(19) United States
(12) Patent Application Publication
(10) Pub. No.: US 2023/0104973 A1
(43) Pub. Date: Apr. 6, 2023

(54) PRINTING FLUID RESERVOIRS FLUIDICALLY COUPLED TO BOTTLE SEATS AND CHARGING PORTS

(71) Applicant: Hewlett-Packard Development Company, L.P., Spring, TX (US)

(72) Inventors: John Patrick STURMAN, Vancouver, WA (US); Paul Allan OSBORNE, Vancouver, WA (US); Wesley R. SCHALK, Vancouver, WA (US)

(73) Assignee: Hewlett-Packard Development Company, L.P., Spring, TX (US)

(21) Appl. No.: 17/909,949

(22) PCT Filed: Mar. 19, 2020
(86) PCT No.: PCT/US2020/023669

§ 371 Date: Sep. 7, 2022

(51) Int. Cl. B41J 2/175

(52) U.S. Cl. CPC B41J 2/17523; B41J 2/17596

(57) ABSTRACT

According to examples, an apparatus may include a chassis having an interior region and a first printing fluid reservoir arranged within the interior region of the chassis. The chassis may fix the first printing fluid reservoir relative to a second printing fluid reservoir. The apparatus may also include a bottle seat that may define a charging port in fluidic communication to the first printing fluid reservoir to convey refill printing fluid received at the charging port to the first printing fluid reservoir. A fluidic interface may be arranged on the chassis and fluidically coupled to the first printing fluid reservoir to convey the printing fluid outside the chassis to a print head.

### BACKGROUND

A printer is a device that applies a material (e.g., ink, toner, dye, agent, etc.) to a medium (e.g., paper). Printers may vary in type, and examples include laser printers, inkjet printers, solid ink printers, thermal printers, dye-sublimation printers, 3D printers, and others. The material the printer applies to the medium is consumed during printing and therefore may in some types of printers be replenished.

### BRIEF DESCRIPTION OF DRAWINGS

Features of the present disclosure are illustrated by way of example and not limited in the following figure(s), in which like numerals indicate like elements, in which:

FIG. 1 depicts a block diagram of an example apparatus that may include printing fluid reservoirs fluidically coupled to bottle seats and charging ports;

FIG. 2 depicts a block diagram of an example printing system in which an apparatus including printing fluid reservoirs fluidically coupled to bottle seats and charging ports may be implemented; and

FIG. 3 depicts a block diagram of an example modular printing fluid delivery apparatus including a chassis to hold a plurality of printing fluid reservoirs, a charging port to convey refill printing fluid, a fluidic interface to convey printing fluid from the plurality of printing fluid reservoirs to outside the chassis, an electrical interface coupled to a controller outside the chassis, and a mechanical interface to mount the chassis in a printing system.

### DETAILED DESCRIPTION

Disclosed herein are apparatuses and systems that may include a modular printing fluid delivery apparatus that may be inserted into and removed from a printing system. That is, the components of the printing fluid delivery apparatus discussed in the present disclosure may be combined into an integrated assembly housed within a chassis that may be removably inserted into a printing system. In addition, the printing fluid supply apparatus may not include fixed printing fluid supplies (e.g., may be refilled with printing fluid) and may have defined interfaces for mechanical, fluidic, and electrical connections to a printing system into which the printing fluid supply apparatus may be inserted.

In some examples, the modular printing fluid delivery apparatus disclosed herein may include a chassis to hold a plurality of printing fluid reservoirs together. The chassis may have an interior region to accommodate a first printing fluid reservoir, in which the first printing fluid reservoir may be fixed relative to a second printing fluid reservoir by the chassis. In addition, the printing fluid delivery apparatus may include a bottle seat that may define a charging port that may be arranged either on the chassis or the first printing fluid reservoir itself. The charging port may be fluidically coupled to the first printing fluid reservoir to convey refill printing fluid received at the charging port to the first printing fluid reservoir. A fluidic interface may also be arranged on the chassis and fluidically coupled to the first printing fluid reservoir to convey the printing fluid outside of the chassis to, for instance, a print head of a printing system.

The charging port may be located on the chassis such that the charging port may be accessible from an exterior of the printing system when the printing fluid delivery apparatus is inserted into the printing system. The charging port may be connected to the printing fluid reservoir by a charging conduit, which may fluidically couple the charging port to a printing fluid pump and may allow the printing fluid reservoir to be positioned within the interior of the printing system independent of the position of the charging port, which may simplify the arrangement of the printing system.

In certain examples, the printing fluid pump may be employed to draw printing fluid from a printing fluid refill bottle, which may reduce the amount of time that may be consumed in adding refill printing fluid to, for instance, the printing fluid reservoirs of the printing system. By way of particular example, a large amount of time may be used to refill large capacity printing fluid reservoirs (e.g., greater than 250 mL). In some examples, the charging conduit may be connected to the printing system supply conduit between the printing fluid reservoir and the printing fluid pump, which may allow the printing fluid pump employed to communicate printing fluid to a print head assembly to also drive refill printing fluid from the printing fluid refill bottle into the printing fluid reservoir. In some examples, the printing fluid pump may be employed to supply printing fluid to the print head assembly, to recirculate the printing fluid within the printing system, to return excess printing fluid to the refill bottles when the printing fluid reservoirs are full during the refill process, to enable removal of printing fluid out of the printing system into a bottle during service or end of printer life application, or another appropriate type of operation based on the application.

In some continuous printing fluid delivery systems, printing fluid consumed during printing may be periodically replaced, without, for instance, replacing a cartridge that may house printing fluid. Instead, refill of printing fluid into the continuous printing fluid delivery systems may generally include the printing fluid reservoir being accessed by opening the printing system and coupling a printing fluid refill bottle to the printing fluid reservoir. Once the printing fluid refill bottle is coupled to the printing fluid reservoir, refill printing fluid may be transferred from the printing fluid refill bottle to the printing fluid reservoir. In some examples, gravity may be used to flow the refill printing fluid from the refill printing fluid bottle and into the printing fluid reservoir through a fill port on, e.g., defined by and local to, the printing fluid reservoir. The printing fluid refill bottle may thereafter be uncoupled from the printing fluid reservoir, the housing of the printing system closed, and the printing system returned to operation.

Generally, in continuous printing fluid supply system designs, aspects of the mechanical, electrical, and/or fluidic functions may be integrated with other subsystems of the printing system. As printing fluid delivery systems (or Ink Delivery Systems, or IDSs) in continuous printing fluid supply systems (or Continuous Ink Supply Systems, or CISSs) may include many integrated components that may need replacement if individual part failures occur, service costs and downtime may be relatively high when individual part failures occur. That is, when a part failure occurs in printing fluid delivery systems with integrated components, access to the part in printing fluid delivery systems such that the part may be replaced or repaired may be difficult and time-consuming. In addition or in other cases, once parts are replaced in the field, testing of the continuous printing fluid system (e.g., leak testing) may be performed to ensure that the printing system is operating property after service. However, maintenance and testing in the field, such as leak testing, may result in increased risk of leaks in the system, requiring increased service time and cost, or in some cases requiring follow-up service.

The apparatuses and systems disclosed herein may overcome these issues by improving serviceability by enabling replacement of a module, which may be replaced in a shorter amount of time than repairing individual components, thereby reducing service time and costs. The modular design of the apparatuses disclosed herein may also enable efficient testing (e.g., leak testing) of aspects of the continuous printing fluid delivery apparatus during fabrication, prior to installation in the printing system.

Furthermore, the present apparatuses and systems may include a battle seat located on the exterior of the printing system and remote from the printing fluid reservoir. Arranging the bottle seat remotely with respect to the printing fluid reservoir may eliminate the need for the user to access the interior of the printing system to refill the printing fluid reservoir. Arranging the bottle seat remotely also may provide flexibility in the shape and location of the chassis for the modular fluid delivery apparatus disclosed herein.

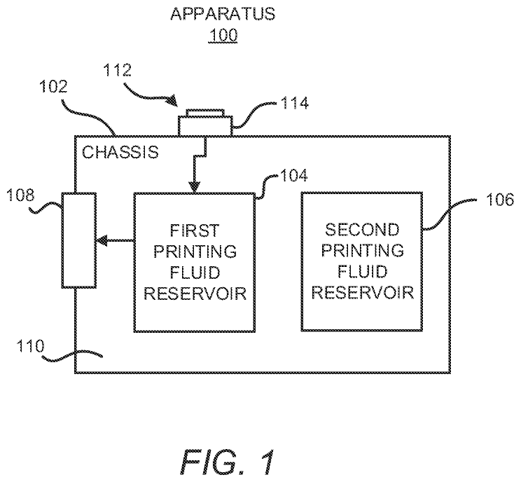

Reference is first made to FIG. 1, which depicts a block diagram of an example apparatus 100 that may include printing fluid reservoirs fluidically coupled to bottle seats and charging ports. It should be understood that the example apparatus 100 may include additional features and that some of the features described herein may be removed and/or modified without departing from the scope of the apparatus 100.

As shown in FIG. 1, the apparatus 100, which may also be referenced herein as a printing fluid delivery apparatus or a modular printing fluid delivery apparatus, may have a chassis 102 having an interior region 110. The interior region 110 may house the components of printing fluid delivery apparatus 100. In some examples, the chassis 102 may group a plurality of printing fluid reservoirs 104 and 106 together. It should be understood that, while two printing fluid reservoirs 104 and 106 are shown in FIG. 1, various numbers of printing fluid reservoirs may be disposed in the chassis 102. By way of particular examples, the chassis 102 may include four printing fluid reservoirs for some color printer applications, one for each of cyan, magenta, yellow, and black (or CMYK), or the chassis 102 may include six or more reservoirs for some photographic applications. In these examples, a first printing fluid reservoir 104 may be arranged within the interior region 110 of the chassis 102 such that a position of the first printing fluid reservoir 104 may be fixed relative to other printing fluid reservoir(s) 106 by the chassis 102. In some examples, mechanical connections, including as screws, hooks, tabs, straps, and/or the like, may be disposed within the chassis 102 and may be used to fix the first and second printing fluid reservoirs 104 and 106 within the chassis 102.

As also shown in FIG. 1, the chassis 102 may support a fluidic interface 108 to convey printing fluid from the plurality of printing fluid reservoirs 104 and 106 to outside of the chassis 102. That is, for instance, the fluidic interface 108 may be arranged on the chassis 102 and may be fluidically coupled to the first printing reservoir 104 such that printing fluid housed in the first printing fluid reservoir 104 may be conveyed outside of the chassis 102 through the fluidic interface 108. The chassis 102 may further include a bottle seat 112 that may define a charging port 114. The charging port 114 may be in fluidic communication to the first printing fluid reservoir 104 to convey refill printing fluid received at the charging port 114 to the first printing fluid reservoir 104.

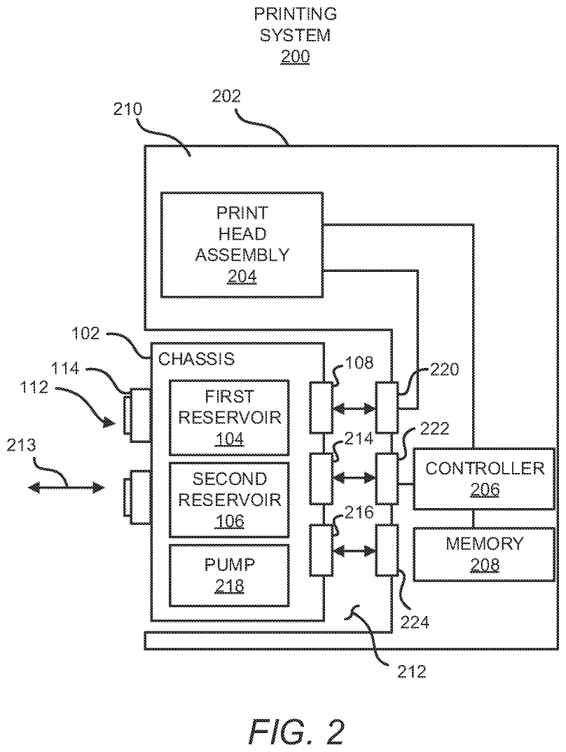

Reference is now made to FIG. 2, which depicts a block diagram of an example printing system 200 in which the apparatus 100 depicted in FIG. 1 may be implemented. It should be understood that the example printing system 200 may include additional features and that some of the features described herein may be removed and/or modified without departing from the scope of the example printing system 200.

The printing system 200 may include a body 202 (or a housing), a print head assembly 204 (which may be or may include a print head), a controller 206, and a memory 208. The body 202 may include an interior to accommodate various components of the printing system 200. In some examples, the interior of the body 202 may include a first region 210 to accommodate the print head assembly 204 and a second region 212 to accommodate the apparatus 100. In these examples, the print head assembly 204 may be arranged in the first region 210 of the interior of the body 202 and the apparatus 100 may be arranged in a second region 212 of the interior of the body 202. The second region 212 may be physically separate from the first region 210 such that, for instance, the chassis 102 of the apparatus 100 may be removably mounted to the body 202.

As depicted in FIG. 2, the chassis 102 may be inserted into the second region 212 of the interior of the body 202 as depicted by arrow 213. Particularly, the second region 212 may be a recess or a chamber formed in the body 202 of the printing system 200 into which the chassis 102 may be removably inserted. In some examples, a cover (not shown) may be provided to cover the second region 212 after the chassis 102 is placed in a seated position within the second region 212.

As previously described with respect to FIG. 1, the chassis 102 may include the first printing fluid reservoir 104, the second printing fluid reservoir 106, and the fluidic interface 108. As shown in FIG. 2, printing fluid from the first and second printing fluid reservoirs 104 and 106 may be conveyed through the fluidic interface 108 to the print head assembly 204. In addition to the fluidic interface 108, the chassis 102 may include an electrical interface 214 through which electrical signals may be communicated and a mechanical interface 216 to mount the chassis 102 to the body 202 of the printing system 200.

On the body 202 side, the printing system 200 may include corresponding interfaces to couple with the fluidic interface 108, electrical interface 214, and mechanical interface 216 of the chassis 102. By way of particular example, the printing system 200 may include a second fluidic interface 220, a second electrical interface 222, and a second mechanical interface 224 that may respectively couple to the fluidic interface 108, the electrical interface 214, and the mechanical interface 216 of the chassis 102. The second interfaces 220-224 on the body 202 may be mounted on a surface inside the second region 212 of the body 202. The second fluidic interface 220 may be positioned in the second region 212 such that the second fluidic interface 220 is aligned with and connects to the fluid interface 108 when the chassis 102 is inserted into the second region 212. Likewise, the second electrical interface 222 may be positioned in the second region 212 such that the second electrical interface 222 is aligned with and connects to the electrical interface 214 when the chassis 102 is inserted into the second region 212. Furthermore, the second mechanical interface 224 may be positioned in the second region 212 such that the second mechanical interface 224 is aligned with and connects to the mechanical interface 216 when the chassis 102 is inserted into the second region 212.

The fluidic interface 108 and the second fluidic interface 220 may include connector pairs to provide a fluidic connection from the chassis 102 to the print head assembly 204 of the printing system 200. For example, fluidic interface 108 and the second fluidic interface 220 may include drip-proof or leak-proof type connectors (e.g., a needle septum type connector). A plurality of pairs of fluidic connections may be provided for each of the plurality of printing fluid reservoirs 104, 106 mounted together in the chassis 102. In some examples, the fluidic interface 108 may include a plurality of connectors and the second fluidic interface 220 may include matching connectors. In any regard, the fluidic interface 108 may automatically connect to and form a fluidic connection with the second fluidic interface 220 when the chassis 102 is pushed with sufficient force and with sufficient displacement into the second region 212.

The electrical interface 214 may be coupled to various types of electrical components within the chassis 102. By way of particular example and for purposes of illustration, the electrical interface 214 may be coupled to a pump 218 within the chassis 102 in which the pump 218 may pump refill printing fluid from the charging port 114 to the first or second printing fluid reservoirs 104 or 106. The pump 218 may also pump printing fluid from the first or second reservoir 104 or 106 to the fluidic interface 108. In these examples, the electrical interface 214 may provide connections through which electrical energy may be supplied to the pump 218, in which the controller 206 may control the supply of the electrical energy to the pump 218. The electrical interface 214 may also or alternatively accommodate electrical connections for other types of electrical components in the apparatus 100. By way of particular example, the chassis 102 may include sensors (e.g., flow sensors, bottle sensors, print fluid level sensors, etc.), switches, lights, or the like, and the electrical interface 214 may provide electrical power and may convey signals between these components and the controller 206.

The mechanical interface 216 and the second mechanical interface 224 may facilitate mounting of the chassis 102 to the body 202 of the printing system 200. The mechanical interfaces 216 and 224 may include a plurality of screws, hooks, tabs, rails, or the like, to locate and secure the chassis 102 within the second region 212 of the body 202. By way of particular example, the mechanical interfaces 216 and 224 may include corresponding rails on the chassis 102 and the body 202 to enable the chassis 102 to be slid into a seated position within the second region 212. In some examples, responsive to the chassis 102 being seated into position with respect to the second region 212, the fluidic interfaces 108 and 220 and/or the electrical interfaces 214 and 222 may automatically establish connections with each other. Alternatively or additionally, some connections may be manually established once the chassis 102 is assembled (e.g., slid, inserted, or placed) into the seated position.

In some examples, the second region 212 may be positioned within the body 202 of the printing system 200 to be easily accessible from outside of the printing system 200 to facilitate installation and removal of the chassis 102 and to provide access for refill bottles to be easily placed on the bottle seat 112. By way of particular example, the bottle seat 112 for receiving the refill bottle may be disposed on a surface of the chassis 102. The charging port 114 may be made accessible from outside of the body 202 while the chassis 102 is mounted inside the body 202. In some examples, multiple bottle seats 112 for multiple printing fluid reservoirs 104, 106 mounted inside the chassis 102 may be provided on the chassis 102. In some examples, the multiple bottle seats 112 may be grouped together in a particular region. In some examples, multiple bottle seats 112 may be grouped together, each being fluidically coupled to a corresponding printing fluid reservoir 104, 106 placed remotely relative to the bottle seats 112 via a charging conduit. Alternatively or additionally, the bottle seats 112 may be provided separately based on a position of a corresponding printing fluid reservoir 104, 106. By way of particular example, the bottle seat 112 may be mounted directly on the first printing fluid reservoir 104. In this case, tubing or charging conduit to route the refill printing fluid to the first printing fluid reservoir 104 may not be needed inside the chassis 102.

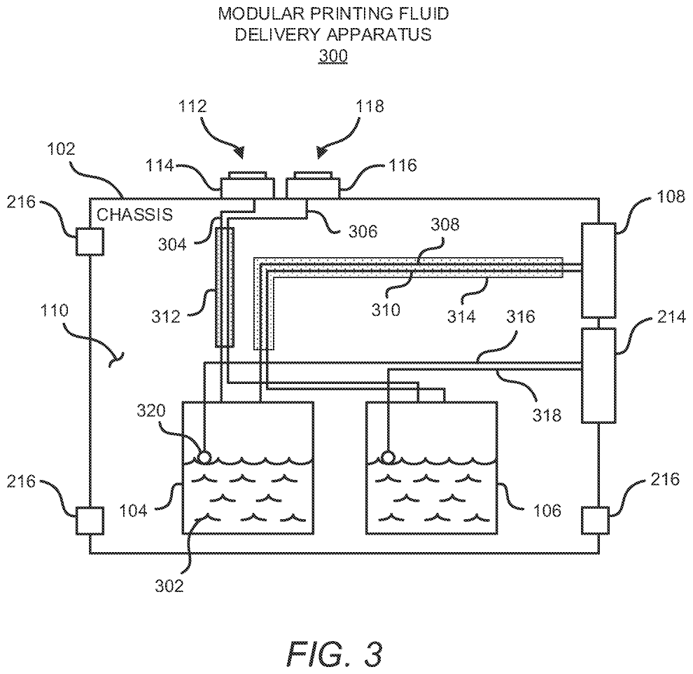

Reference is now made to FIG. 3, which depicts a block diagram of an example modular printing fluid delivery apparatus 300. It should be understood that the example printing fluid delivery apparatus 300 may include additional features and that some of the features described herein may be removed and/or modified without departing from the scope of the example printing fluid deliver apparatus 300.

As shown in FIG. 3, the modular printing fluid delivery apparatus 300 may include a chassis 102 that may hold a plurality of printing fluid reservoirs 104 and 106, bottle seats 112 and 118 that may define respective charging ports 114 and 116 to convey refill printing fluid, a fluidic interface 108 to convey printing fluid 302 from the plurality of printing fluid reservoirs 104, 106 to outside of the chassis 102, an electrical interface 214 that may be coupled to a controller 206 outside of the chassis 102, and a mechanical interface 216 to mount the chassis 102 in a printing system 200.

In some examples, a first charging port 114 may be fluidically coupled to the first printing fluid reservoir 104 and a second charging port 116 may be fluidically coupled to the second printing fluid reservoir 106. A first charging conduit 304 may be fluidically coupled between the charging port 114 and the first printing fluid reservoir 104 and a second charging conduit 306 may by fluidically coupled between the second charging port 116 and the second printing fluid reservoir 106. The first and second charging ports 114 and 116 may be fixed to a surface of the chassis 102. Alternatively or additionally, the first and second charging ports 114 and 116 may be fixed directly to a surface of the first and second printing fluid reservoirs 104 and 106, respectively.

In some examples, the first and second printing fluid reservoirs 104 and 106 may be fluidically coupled to the fluidic interface 108 such that the printing fluid 302 in the first and second printing fluid reservoirs 104 and 106 may be conveyed outside of the chassis 102, e.g., to the print head assembly 204. The fluidic interface 108 may include a plurality of connectors for a plurality of printing fluid reservoirs 104 and 106. In some examples, the first printing fluid reservoir 104 may be fluidically coupled to the fluidic interface 108 via a first print head assembly conduit 308 and the second printing fluid reservoir 106 may be fluidically coupled to the fluidic interface 108 via a second print head assembly conduit 310.

In some examples, the first and second printing fluid reservoirs 104 and 106 may be positioned away from the charge ports 114 and 116 and/or the fluidic interface 108. In these examples, the conduits 304, 306, 308, and 310 may be routed a distance within the chassis 102 to facilitate the connections at different areas of the chassis 102. The conduits 304, 306, 308, and 310 may be flexible tubes, or the like. By way of particular example, in order to prevent kinks or other types of damage to the conduits, the conduits 304, 306, 308, and 310 may be routed in raceways 312 and 314 formed within the chassis 102. The raceways 312 and 314 may be formed as channels and/or may include tabs and/or guides to guide the conduits 304, 306, 308, and 310 along a desired route and to provide protection against damage from extemal forces, such as through movement/shifting of the tubes, by external impact, or the like.

In some examples, the electrical interface 214 may be arranged on the chassis 102 and may be electrically coupled to convey electrical signals between an electrical component in the chassis 102 and a controller 206 disposed outside the chassis 102. As previously described, the chassis 102 may include various types of electrical components including, for example, fluidic pumps, sensors (e.g., flow sensors, bottle sensors, etc.), switches, lights, or the like, and power and signals to these components may be provided through the electrical interface 214. In some examples, a printing fluid level sensor 320 may be disposed inside the first printing fluid reservoir 104. Signals between the printing fluid level sensor 320 and the controller 206 may be conveyed along connections 316, 318 through the electrical interface 214. In some examples, the electrical interface 214 may include a connector that has a corresponding connector at the electrical interface 222 on the printing system 200.

In some examples, a printing fluid pump 218 (FIG. 2) may be fluidically coupled to the charging port 114 and the first printing fluid reservoir 104 through the charging conduit 304. The printing fluid pump 218 may also be coupled to the second charging port 116, the second printing fluid reservoir 106, and through the charging conduit 306. Electrical connections to the printing fluid pump 218 may be conveyed outside the chassis 102 to the controller 206 through the electrical interface 214.

In some examples, a mechanical interface 216 may be fixed to the chassis 102 to mount the chassis 102 within the body 202 (or a housing) of the printing system 200. The mechanical interfaces 216 may be arranged at different portions of the chassis 102 to provide multiple mounting points. As previously described, the mechanical interfaces 216 may include a plurality of screws, hooks, tabs, rails, or the like, to locate and secure the chassis 102 within the second region 212 of the body 202 of the printing system 200.

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote one of a particular element or multiple ones of a particular element. As used herein, the term “includes” means includes but not limited to, the term “including” means including but not limited to. The term “based on” may mean based in part on.

Although described throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a chassis having an interior region;
a first printing fluid reservoir arranged within the interior region of the chassis, a position of the first printing fluid reservoir being fixed relative to a second printing fluid reservoir by the chassis;
a bottle seat defining a charging port, the charging port being in fluidic communication to the first printing fluid reservoir to convey refill printing fluid received at the charging port to the first printing fluid reservoir; and
a fluidic interface arranged on the chassis and being fluidically coupled to the first printing fluid reservoir to convey the printing fluid outside the chassis to a print head.

2. The apparatus of claim 1, wherein the charging port is fixed directly to the first printing fluid reservoir.

3. The apparatus of claim 1, further comprising a charging conduit fluidically coupled between the charging port and the first printing fluid reservoir, the charging port being fixed to a surface of the chassis.

4. The apparatus of claim 3, further comprising a printing fluid pump fluidically coupling the charging port with the first printing fluid reservoir through the charging conduit.

5. The apparatus of claim 1, wherein the fluidic interface comprises a plurality of connectors for a plurality of printing fluid reservoirs, the fluidic interface to convey printing fluid from the plurality of printing fluid reservoirs to outside the chassis to the print head.

6. The apparatus of claim 1, further comprising an electrical interface arranged on the chassis and electrically coupled to convey electrical signals between a printing fluid pump and a controller disposed outside of the chassis.

7. The apparatus of claim 1, further comprising a mechanical interface fixed to the chassis, the mechanical interface to mount the chassis within a housing of a printing system.

8. A printing system comprising:
a body having an interior;
a print head arranged in a first region of the interior of the body; and
a chassis removably arranged in a second region of the interior of the body, the second region being separate from the first region, the chassis comprising:
a first printing fluid reservoir arranged within the chassis; and
a bottle seat defining a charging port, the charging port being fluidically coupled to the first printing fluid reservoir to convey refill printing fluid received at the charging port to the first printing fluid reservoir, wherein the charging port is accessible from outside of the body while the chassis is mounted inside the body.

9. The printing system of claim 8, wherein the chassis fixes the first printing fluid reservoir relative to a second printing fluid reservoir arranged in the chassis.

10. The printing system of claim 8, further comprising a charging conduit fluidically coupling the charging port and the first printing fluid reservoir, the charging port being fixed to a surface of the chassis.

11. The printing system of claim 8, further comprising a printing fluid pump fluidically coupling the charging port with the first printing fluid reservoir through a charging conduit.

12. The printing system of claim 8, further comprising:
a first electrical interface arranged on the body; and
a second electrical interface arranged on the chassis and to be electrically coupled to the first electrical interface to convey electrical signals between an electrical component within the chassis and a controller disposed outside of the chassis.

13. The printing system of claim 8, further comprising
a first fluidic interface arranged on the body and fluidically coupled to the print head; and
a second fluidic interface arranged on the chassis and fluidically coupled to the first printing fluid reservoir, the first fluidic interface to be fluidically coupled to the second fluidic interface when the chassis is mounted to the body at the second region of the interior of the body, wherein the second fluidic interface comprises a plurality of connectors for a plurality of printing fluid reservoirs arranged in the chassis, the second fluidic interface to convey printing fluid through the first fluidic interface to the print head.

14. A modular printing fluid delivery apparatus comprising:
a chassis having an interior;
a first printing fluid reservoir arranged within the chassis, the chassis fixing the first printing fluid reservoir relative to a second printing fluid reservoir within the chassis;
a bottle seat defining a charging port, the charging port being in fluidic communication to the first printing fluid reservoir to convey refill printing fluid received at the charging port to the first printing fluid reservoir, wherein the charging port is to be accessible while the chassis is mounted within a housing of a printing system;
a fluidic interface arranged on the chassis and being fluidically coupled to the first printing fluid reservoir to convey the printing fluid outside of the chassis to a print head of the printing system;
an electrical interface arranged on the chassis and electrically coupled to a controller disposed outside the chassis; and
a mechanical interface fixed to the chassis, the mechanical interface to mount the chassis within the housing of the printing system.

15. The modular printing fluid delivery apparatus of claim 14, further comprising:
a charging conduit fluidically coupling the charging port to the first printing fluid reservoir, the charging port being fixed to a surface of the chassis and being accessible while the chassis is mounted within the housing of the printing system; and
a printing fluid pump fluidically coupling the charging port with the first printing fluid reservoir through the charging conduit.
